(19) United States
(12) Patent Application Publication
(10) Pub. No.: US 2017/0192984 A1
(43) Pub. Date: Jul. 6, 2017

(54) SYSTEM AND METHOD FOR OPTIMIZING AUDIENCE DATA AND TRACKING

(71) Applicant: Joseph Titlebaum, Bethesda, MD (US)

(72) Inventors: Joseph Galarneau, New York, NY (US); Ihab Rimawi, New York, NY (US); Joseph Titlebaum, Bethesda, MD (US)

(73) Assignee: Mezzobit Inc., Bethesda, MD (US)

(21) Appl. No.: 14/986,546

(22) Filed: Dec. 31, 2015

(51) Int. Cl. G06F 17/30; H04L 29/08

(52) U.S. Cl. CPC G06F 17/3089; H04L 67/02; G06F 17/30864; G06F 17/30873

(57) ABSTRACT

In a computing device executing one or more tags embedded on a web page; identifying actions of each tag, such as data collected, user tracking, visual interface modification, and data recipients; collecting external economic and operational metrics related to website and business operations; executing experiments to vary tag actions and using statistical methods to identify the correlation of tag actions with economic and operational metrics; displaying the outcome of such experiments; developing rules based on statistical correlations and user input to control the operation of tags to optimize the effect on metrics; and implementing rules in a system to control tag execution.

This patent application claims priority to U.S. Provisional Patent Application Ser. No. 62/098,815, filed Dec. 31, 2014 and incorporated herein by reference in its entirety.

### TECHNICAL FIELD

The present disclosure relates to data management and data exchange in web browsers and related mobile apps.

### BACKGROUND

As the Internet and Internet commerce have expanded, various website owners and third parties have sought to track a variety of data about individuals who visit their websites. In particular, website owners often wish to gather and share a variety of different analytic data about the visitors who view their webpage. In many cases, this analytic data can be used to determine what advertisements to display to a visitor and to determine what fees are due to be paid to various external advertisers. Other applications of this data may be to customize the interaction with a visitor to an e-commerce website or determine whether a third party affiliate should be paid referral fees for directing a visitor to a website.

One conventional method for generating analytic data on website visitors is through the use of tags. In at least one conventional form, a tag is a hidden element within a webpage that causes some action to occur on a webpage when it is “fired.” In particular, in at least one implementation, a tag is a piece of code, e.g., JavaScript, that is placed within a webpage and allows a webpage owner to track information about the visitors who download and execute the particular piece of code. For example, a tag can comprise a transparent GIF or a tracking pixel, which is placed within the code of a webpage. The actual transparent GIF or tracking pixel can be stored on a separate server from the actual webpage. The tag is fired when the browser requests the transparent GIF or tracking pixel from the separate server. When the separate server receives the request from the browser, the server can gather various analytic data about the requestor. Tags can be provided by first parties (i.e., the operator of the website), but often are provided to the first party by third parties that offer digital services, such as ad trafficking, social networks, or analytics. The data that is transmitted to these third parties is often used in the provision of services back to the first party or is monetized directly, as in the case of data brokers.

Once executed, a tag can gather information such as where the visitor came from (e.g., what webpage or search engine), what keywords were used to find the webpage, whether a particular advertisement directed a visitor to the page, and other related data. A tag may, for example, perform operations such as:
Examine local browser data pertaining to the specific webpage user (i.e., the party interacting with the webpage), as permitted by browser configuration. Examples include content on the page, local machine OS, referring page, or clickstream data.
Examine cookies contained on the local machine, as well as setting new cookies.
Transmit data to external servers.
Modify the presentation of the current webpage or performing other webpage user interface actions, such as displaying pop-ups or pop-unders.

In many situations, a webpage can comprise multiple tags from a variety of different parties. For example, a particular webpage may contain a Google Analytics tag, a Facebook tag, a page counter tag, a weather tag, and other common tags. The average website contains about 20 tags, and some sites may have more than 100.

One development to help with issues relating to the control of tags within websites has been the implementation of tag management systems. Conventional tag management systems function by replacing the plurality of individual tags on a webpage with a single master tag (in some implementations, referred to as a “container tag”). When the master tag is loaded, the tag management system identifies, using a set of rules, which of the plurality of individual tags should be allowed to run on the webpage. The tag management system can then inject the identified tags into the webpage through the master tag.

A properly implemented tag management system can provide the benefits of, among other things, only requiring a single tag to be implemented on each page of a website and providing a single interface through which all of the tags can be controlled.

One development relating to the proliferation of tags on websites has been the sharing of various information about the visitors to a website with various third parties, including for example, social networks, sharing widgets, optimization services, advertising networks and potential advertisers participating in bidding transactions for the opportunity to present an advertisement on a particular website.

Data sharing can be implemented through APIs and other server-side technologies that do not involve the insertion of tags on a website. And data control systems can be implemented to control the sharing of data about website users through APIs and other technologies that do not use JavaScript tags.

The owners of a website often have little control over who data is being shared with and may be desirous of maximizing the value of these data exchanges. A problem arises when website operates must determine which controlling activities would result in economic benefit. There are also challenges to prevent the leakage of information about the website audience to unknown third parties. This is commonly referred to as “data leakage”.

The average tag performs dozens of discrete data collection and tracking actions. When multiplied by the number of tags that interact with a single pageview, there could be hundreds or thousands of separate transactions. Some of these are required for tags to properly operate and provide the services for which the digital operator has engaged the third party. Other tags are directly related to services that generate revenue for the website operator, such as the display of advertisements, the payment of affiliate referral fees, or the collection of data that is sold to third parties. But there are other operations that contribute to data leakage that can be curtailed without operational harm. And of these nonessential operations, in can be difficult to know which have the largest impact to economic harm—i.e., if they were reversed, the website operator would see the greatest benefit.

Multivariate testing employs advanced statistical methods to permit many variables to be simultaneously tested in a series of related experiments instead of testing each variable independently. The result is an analysis that quantifies that level of sensitivity that each variable has within the entire system: In other words, how much change would be seen in the output for a specified level of change in one of the input variables. In the case of data leakage, the desired output may be the pricing of a digital operator's ad unit in a programmatic environment or the arbitrage value of an audience member on an open data or advertising network. For an e-commerce site, such testing may compare the collection of data by tags with the total value of goods purchased by a visitor or the abandonment rate of the buy process. For a site operated by a brand marketer for purposes of promoting, but not selling, a product, such testing may compare data collection with the conversion rates of certain economically desirable activities, such as signing up for email newsletters, sharing links on social networks, or consuming additional marketing content.

The method of multivariate testing in a tag environment would run small experiments by making slight controlled changes to the operation of specific tags firing on specific visits using a tag management system or other technology that can affect the loading and execution of tags in a web page. The system would monitor the activity of all other tags on the page, as well as gather data from external systems. Data gathering for the experiment would include the current visitor session where the changes were made, as well as a time period of days, weeks or months thereafter where the effects may manifest themselves in subtle ways. This would permit the statistical analysis to determine the correlation between changes in a specific tag's operation with variables gathered from other tags and external systems.

The outcome of the multivariate testing could be fed back into a tag management or similar data control system to create data collection and tracking control rules that could automatically optimize the performance of these tags in order to improve revenue or other important business metrics. This could be configured to dynamically optimize the web and mobile app data environment.

### BRIEF DESCRIPTION OF THE DRAWINGS

FIG. 1 is illustrates an architectural schematic diagram of a system for using a master tag to monitor and control other tags on a website, according to an embodiment.

FIG. 2 is illustrates a depiction of a webpage in communication with a plurality of servers, according to an embodiment.

FIG. 3 illustrates another depiction of a webpage in communication with a plurality of servers, according to an embodiment.

FIG. 4 is a flowchart illustrating the process of optimizing the sharing of audience data to identify the most desirable outcomes for the owner of the website.

### DESCRIPTION OF EXAMPLE EMBODIMENTS

### Overview

In a computing device executing a master tag embedded in a webpage, a first subsequent tag in the webpage is identified. A second subsequent tag called by the first subsequent tag is also identified. Information collected by one or more of the first and second subsequent tags is identified. A location is identified, to which the collected information is sent. An indication is provided to a user of the system described herein, indicating the information collected and the location to which the collected information is sent. In addition, the system can alternatively rely on the use of APIs to control the flow of data to third parties with limited use of third party tags. In addition, the master tag or equivalent controller may determine a number of cookies dropped by the first subsequent tag; determine one or more characteristics of each cookie dropped by the first subsequent tag; and indicate the number of cookies dropped and the one or more characteristics of each cookie dropped. This processing allows for the controlling and tracking of data related to the set of parties interacting with a webpage, i.e., the audience for the webpage. And this processing can dynamically enable and disable the tracking and sharing of data related to the audience of the webpage so as to optimize desirable outcomes for the owner of the website.

Note that the term “user” as used from this point forward refers to a user of the system described herein, e.g., the owner, manager, or administrator of a website in which embedded tags are discovered and/or analyzed.

### EXAMPLE EMBODIMENTS

Implementations of the present invention overcome one or more problems in the art with systems, methods and apparatus configured to use a tag management system and similar tools for controlling website data flows. In one implementation, the tag management system incorporates a master tag into a webpage to identify other tags that are embedded within a webpage. The master tag can monitor, and in some cases control, the execution of those tags. In particular, a master tag can communicate with a server that aids in analysis of other tags within the webpage. Additionally, a master tag can aid in the preparation of data that outlines the various tags that are located within a webpage and provides characteristics about at least some of the tags.

Stated alternatively, the systems and processes described herein allow webpage owners and managers to gain both visibility into tag related transactions and control over them, as well as other data flow transactions. The tag management system is configured to bootstrap over all other tags on the page. This gives the system described herein a measure of dominion over the operation of the embedded tags, including optimizing the impact of the sharing of data from the perspective of the owner of the website.

Furthermore, the systems and processes described herein allow webpage owners and managers to gain visibility and control into data flow transactions which are implemented through APIs or other non-tag based technologies. This gives the system described herein a measure of dominion over the operation of data flows to third parties, including optimizing the impact of the sharing of data from the perspective of the owner of the website.

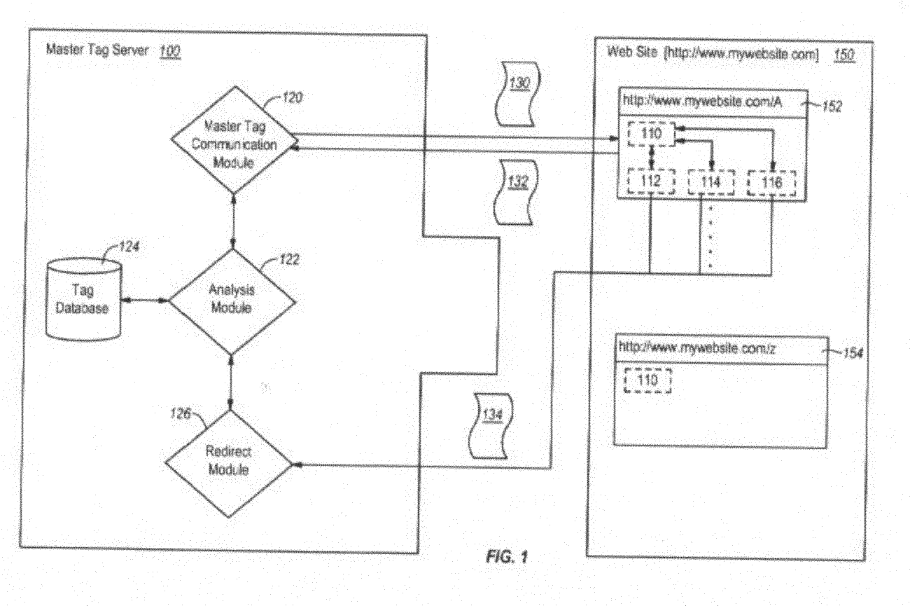

FIG. 1 illustrates an architectural schematic diagram of a system for using a master tag to monitor and control other tags on a website. For example, FIG. 1 shows a master tag server 100 that is in communication with a website 150. In particular, the master tag server 100 can be in communication with a master tag 110 that is embedded within webpages 152 and 154 of the website 150. Additionally, in at least one implementation, the master tag server 100 can be part of a larger tag management system.

A website's embedded tags (written in JavaScript, for example) may be analyzed by the master tag 110 and master tag server 100 as they reside and operate in the browser environment. The analysis can identify what elements in the browser environment are being examined by the tag as part of its programming, for example.

In an embodiment, the system can also determine what data is being transmitted, and to what parties. More generally, the operation of a tag may be controlled in an embodiment, so that a tag payload and/or its functionality may be blocked or altered. In an embodiment, machine learning or other methods may be used to analyze tag activity, to facilitate detecting, categorizing, and/or to order and prioritize the loading of content on a page. Furthermore, in an embodiment, the system can control all sharing of data with third parties, whether through the control of javascript tags or equivalent technologies, such as APIs.

In an embodiment, the analysis module 122 can then analyze the received data. In at least one implementation, the analysis module 122 identifies the tags 112, 114, 116 that are associated with each webpage 152, 154 by referencing a tag database 124 or other functionally similar mechanism or data structure. In particular, the analysis module 122 can compare the data 132 received from a master tag 110 to all of the known tags within the tag database 124. For example, the master tag 110 may send to the master tag server 100 data relating to tag 112. The analysis module 122 can compare the received data 132 to known tags that are contained within the tag database 124.

In an embodiment, the master tag 110 can also override functions of a tag that comes after the master tag. This may be accomplished by superseding the JavaScript or HTML commands in the downstream tag. This feature can be used to stop operation of a tag or redirect its output, for example and without limitation.

For example, in at least one implementation, the master tag 110 can manipulate the execution of the other tags 112, 114, 116 on the webpage 152. For example, the master tag 110 on webpage 152 can prevent tags 112, 114, and 116 from firing, or it can prioritize the order in which the tags fire.

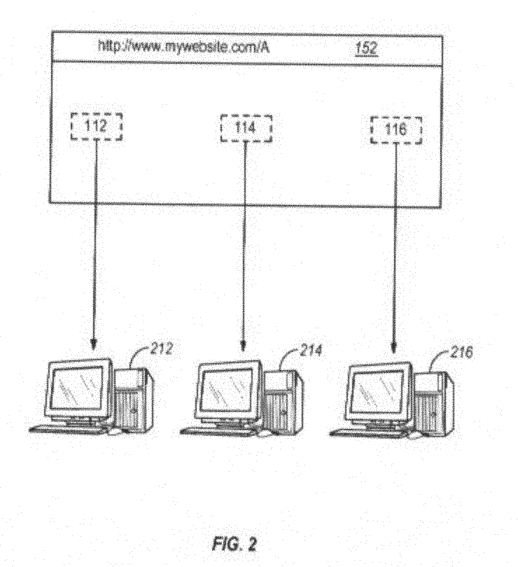

FIG. 2 depicts the webpage 150 of FIG. 1 in communication with a plurality of servers 212, 214, 216. In particular, tag 112 is in communication with external server 212, tag 114 in communication with external server 214, and tag 116 in communication with external server 216. As described above, each tag 112, 114, 116 on a webpage 150 may communicate with a respective external server 212, 214, 216. As the tags fire and communicate with the external servers 212, 214, 216, the external server can gather data about individuals who view a particular webpage 152.

In the implementation depicted by FIG. 2, a master tag 110 has not been embedded within the webpage 152. Additionally, a tag management system is not controlling the managing the tags 112, 114, 116. As depicted, the tags 112, 114, 116 fire when they are loaded. Additionally, the tags 112, 114, 116 communicate to their respective external servers 212, 214, 216 each time they fire.

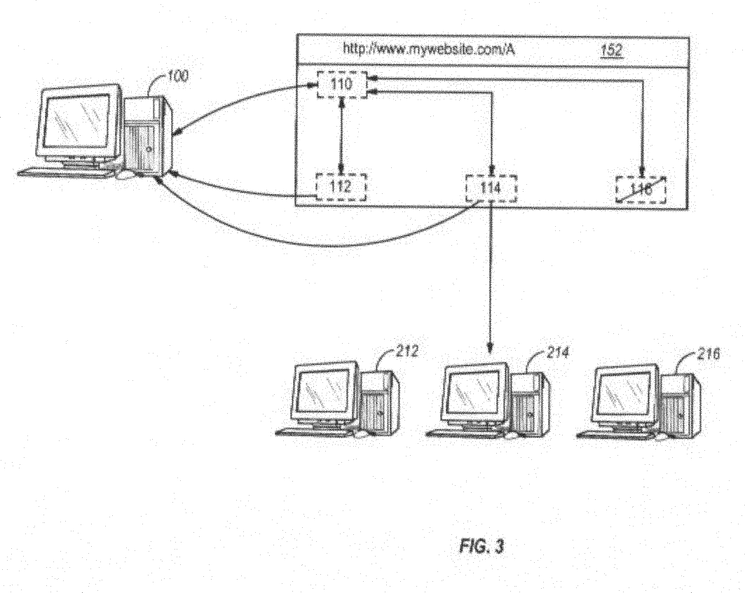

In contrast, FIG. 3 illustrates another depiction of webpage 150 in communication with a plurality of servers 100, 212, 214, 216. In this depiction, the website 150 now includes a master tag 110, in addition to the other tags 112, 114, 116. The webpage 150 of FIG. 3 is being managed by the tag management system.

In an embodiment, master tag 110 and/or analysis module 122 can be configured to monitor various actions of tags embedded on the website or included in the code of a mobile app. These actions being monitored may include the identification of:
data elements that are examined within the visitor's browser or mobile app
data elements that are transmitted to third parties
third parties that receive such data elements.
the items in the web page or mobile app that are visually manipulated
the tracking activities, such as reading or dropping cookies or examining device IDs, that are performed
the loading of additional third-party tags or code that are loaded into the page or mobile app.
the specific technical methods that are used for all of the above.

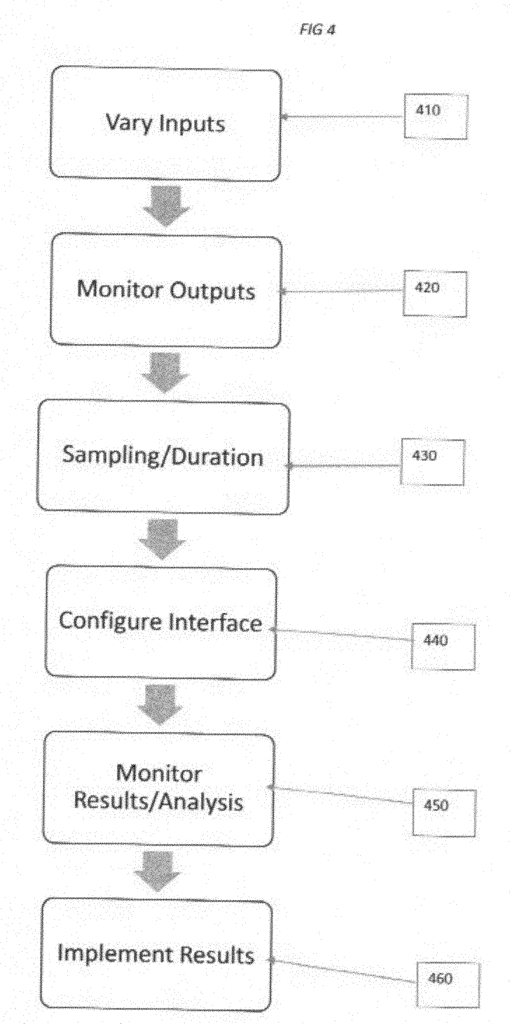

Accordingly, FIGS. 1-3 and the corresponding text illustrate or otherwise describe one or more components, modules, and/or mechanisms for automatically using a master tag to monitor and control other tags on a website. One will appreciate that implementations of the present invention can also be described in terms a flowcharts comprising one or more acts for accomplishing a particular result. For example, FIG. 4 and the corresponding text describe acts in a method for the master tag to conduct multivariate testing as to causation and creating rules to control the management of data flows though the control of tags embedded on the website or the control of APIs or equivalent technologies:

In an embodiment, operation 410 can include specific control actions, such as blocking of tracking cookies or restricting collection and transmission of an individual data element such as referrer. Also included in this parameter 410 could be the identification of data collectors (e.g., Company A) or class of data collectors (e.g., all analytics providers) would be subject to variation and control. These controlling actions could be applied to a single visit or multiple visits, with the system having a method for identifying which visits were subjected to experimentation.

In an embodiment, operation 420 can include the monitoring of output, such as economic factors like ad prices on the website or on the open markets. Other factors could include frequency with which certain advertisers purchased ads, click-through rates, or prices related to the digital operator's data on open markets. For websites not engaged in online advertising, these factors could include the value of orders and types of goods purchased on e-commerce sites, the affiliate fees collected for traffic referral, the conversion rates of visitors towards high-value activities such as email newsletter sign-up and social sharing, and market research metrics such as brand awareness and net promoter scores.

In an embodiment, operation 430 can include the duration and sampling of applicable data during an experiment, such as when the operation is run, and on what types of visitors. This could also include the frequency of targeting visitors for review, the identification of visitor attributes that would target them for review, and how extensive would the testing be in terms of varying the inputs.

In an embodiment, operation 440 can include the configuration of the tag monitoring with various systems, which may include revenue systems such as ad servers, supply-side platforms, e-commerce management systems, affiliate referral systems, or data management platforms, as well as external ad networks, and ad and data exchanges.

In an embodiment operation 450 can include an operational dashboard telling the user how many tests have been run and what type. It also could let the user make adjustments to the testing parameters. In an embodiment, operation 450 could include a variety of advanced statistical tools to analyze the data in different ways, as well as visualize and export the data. This would show the degree of correlation between certain changes in tag operations with resulting variances in metrics.

In an embodiment, operation 460 could create rules that control the operation of tags in a manner to optimize the desired output. These rules could be imported into the tag management or other system that is responsible for controlling tag execution. In an embodiment, operation 450 could monitor the ongoing performance of these rules with regard to their optimizations of outputs and provide automated maintenance and adjustments to these rules. It would also permit the user to make manual adjustments to accommodate changing business requirements.

The embodiments of the present invention may comprise a special purpose or general-purpose computer including various computer hardware components, as discussed in greater detail below. Embodiments within the scope of the present invention also include computer-readable media for carrying or having computer-executable instructions or data structures stored thereon. Such computer-readable media can be any available tangible non-transitory media that can be accessed by a general purpose or special purpose computer.

By way of example, and not limitation, such non-transitory computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The above description is intended by way of example only.

What is claimed is:

1. A method comprising:
in a computing device executing a master tag embedded in a webpage, which may include data collection queries transmitted to other computer systems,
identifying other first subsequent tags that are called by the master tag, directly embedded in a webpage, or called within a webpage;
identifying other second subsequent tags that are called subsequent to the first subsequent tag;
controlling the firing of tags in accordance with rules determined by the user;
identifying specific data elements for retrieval based on parameters; and
delivering those data elements to the original computing device.

2. The method of claim 1, wherein the collection of information relating to the party interacting with the webpage is controlled or delayed in accordance with rules determined by the user.

3. The method of claim 1, wherein the sharing with specified third parties of information relating to the party interacting with the webpage is controlled or delayed in accordance with rules determined by the user.

4. The method of claim 1 wherein data from tag operation and data from other external systems, based on rules determined by the user, are included in experiments subject to multivariate testing to measure the impact of sharing information with third parties and actions upon the operations of the website.

5. The method of claim 1 wherein the statistical correlations of inputs and outputs are used, in conjunction with other rules determined by the user, to create tag operation control rules.

6. The method of claim 5 wherein such tag operation control rules are transmitted to a tag management or other control system for the purpose of modifying tag behavior and the continuing effect of these modifications is measured.

7. One or more non-transitory computer readable storage media encoded with software comprising computer executable instructions wherein, when the software is executed, are operable to:
identify first subsequent tags or called within a webpage, which tags may include data collection queries transmitted to other computer systems,
identify other second subsequent tags that are called subsequent to the first subsequent tag;
control the firing of tags in accordance with rules determined by the user;
identify specific data elements for retrieval based on parameters; and
deliver those data elements to the original computing device,
wherein the executable instructions are incorporated in a master tag embedded in the webpage.

8. The computer readable storage media of claim 7, wherein the collection of information relating to the party interacting with the webpage is controlled or delayed in accordance with rules determined by the user.

9. The computer readable storage media of claim 7, wherein the sharing with specified third parties of information relating to the party interacting with the webpage is controlled or delayed in accordance with rules determined by the user.

10. The computer readable storage media of claim 7, wherein data from tag operation and data from other external systems, based on rules determined by the user, are included in experiments subject to multivariate testing to measure the impact of sharing information with third parties and actions upon the operations of the website.

11. The computer readable storage media of claim 7, wherein the statistical correlations of inputs and outputs are used, in conjunction with other rules determined by the user, to create tag operation control rules.

12. The computer readable storage media of claim 11, wherein such tag operation control rules are transmitted to a tag management or other control system for the purpose of modifying tag behavior and the continuing effect of these modifications is measured.
